(19) United States
(12) Patent Application Publication
(10) Pub. No.: US 2026/0230758 A1
(43) Pub. Date: Aug. 6, 2026

(54) MEMS ACOUSTIC SENSING CHIP, MICROPHONE AND ELECTRONIC DEVICE

(71) Applicant: Weifang Goertek Microelectronics Co., Ltd., Weifang, Shandong (CN)

(72) Inventor: Quanbo Zou, Shandong (CN)

(73) Assignee: Weifang Goertek Microelectronics Co., Ltd., Weifang, Shandong (CN)

(21) Appl. No.: 19/149,626

(22) PCT Filed: Nov. 16, 2023
(86) PCT No.: PCT/CN2023/132085

§ 371 Date: Jul. 21, 2025

(30) Foreign Application Priority Data
Nov. 21, 2022 (CN) 202211457629.X

(51) Int. Cl. H04R 19/04; H04R 7/08; H04R 7/16

(52) U.S. Cl. CPC H04R 19/04; H04R 7/08; H04R 7/16; H04R 2201/003

(57) ABSTRACT

The disclosure includes a MEMS acoustic sensing chip, a microphone, and an electronic device. The MEMS acoustic sensing chip includes a substrate provided with a back cavity, a first diaphragm, a second diaphragm, a backplate, and a support structure; the first diaphragm, the second diaphragm, and the backplate are provided on one side of the substrate through the support structure, the first diaphragm and the second diaphragm are provided with an inner cavity therebetween, and the backplate is suspended in the inner cavity; the support structure is provided with a vent hole, the vent hole being in communication with the back cavity and being independent of the inner cavity; and at least one of the first diaphragm and the second diaphragm is provided with a release hole, which is in communication with the inner cavity.

### CROSS-REFERENCE TO RELATED APPLICATIONS

The present disclosure is a National Stage of International Application No. PCT/CN2023/132085, filed on Nov. 16, 2023, which claims priority to a Chinese patent application No. 202211457629.X filed with the CNIPA on Nov. 21, 2022 and entitled “MEMS ACOUSTIC SENSING CHIP, MICROPHONE, AND ELECTRONIC DEVICE”, both of which are hereby incorporated by reference in their entireties.

### TECHNICAL FIELD

The present disclosure relates to the field of acoustoelectric technology, and particularly to a MEMS acoustic sensing chip, a microphone, and an electronic device.

### BACKGROUND

Double-diaphragm MEMS microphones typically include two diaphragms, and a backplate having through holes is provided between the two diaphragms. To achieve synchronous vibration of the two diaphragms and support them, the prior art involves arranging one or more support pillars between the two diaphragms, and the support pillars pass through the through hole of the backplate and are mechanically connected to two diaphragms respectively.

Since the support pillars must mechanically connect the two diaphragms, the height of the support pillars equals the sum of the thickness of the backplate and the gaps between the two diaphragms and the backplate. Consequently, the height of the support pillars is significantly greater than the thickness of the diaphragms themselves. The double-diaphragm structure connected via the support pillars exhibits a large “equivalent thickness”, which results in low mechanical sensitivity thereof. To address this issue, current solutions involve increasing the area of the diaphragms to compensate for the reduced microphone sensitivity and low signal-to-noise ratio (SNR) caused by insufficient mechanical sensitivity. Additionally, the support pillars are also the most mechanically fragile part. The junctions where the support pillars connect to the diaphragms inherently experience significant stress concentration due to the interface of a plurality of materials. When the diaphragms are subjected to high sound pressure or mechanical impact, the stress concentration there becomes particularly severe, making it highly likely that the diaphragms will fracture and thereby causing failure of the acoustic device.

### SUMMARY

An objective of embodiments of the present disclosure is to provide new technical solutions of a MEMS acoustic sensing chip, a microphone, and an electronic device.

According to a first aspect of embodiments of the present disclosure, a MEMS acoustic sensing chip is provided, which includes a substrate, a first diaphragm, a second diaphragm, a backplate, and a support structure, the substrate being provided with a back cavity;
the first diaphragm, the second diaphragm, and the backplate are provided on one side of the substrate through the support structure, the first diaphragm and the second diaphragm are provided with an inner cavity therebetween, and the backplate is suspended in the inner cavity;
the support structure is provided with a vent hole, the vent hole being in communication with the back cavity and being independent of the inner cavity; and
at least one of the first diaphragm and the second diaphragm is provided with a release hole, the release hole being in communication with the inner cavity.

Optionally, each of the first diaphragm and the second diaphragm includes a support region connected to the support structure, and the vent hole extends through both support regions of the first diaphragm and the second diaphragm.

Optionally, the first diaphragm is provided on one side of the backplate close to the substrate, and the first diaphragm and the substrate are provided with a first cavity therebetween, the first cavity communicating the vent hole with the back cavity. Optionally, each of the first diaphragm and the second diaphragm includes a vibration region covering the back cavity, and the release hole is provided in the vibration region.

Optionally, the release hole has an aperture of less than 0.5 μm.

Optionally, the release hole has an aperture of 0.15 μm to 0.5 μm.

Optionally, on the first diaphragm and/or the second diaphragm, adjacent release holes are spaced apart by 10 μm to 30 μm.

Optionally, the first diaphragm and the backplate are formed with a first gap therebetween and form a first capacitor structure, and the second diaphragm and the backplate are formed with a second gap therebetween and form a second capacitor structure.

Optionally, the backplate is provided with a plurality of through holes, the first diaphragm and the backplate are formed with a first gap therebetween, the second diaphragm and the backplate are formed with a second gap therebetween, and the plurality of through holes communicate the first gap with the second gap;
when the second diaphragm is subjected to sound pressure and moves towards the first diaphragm, air in the inner cavity flows, and after sequentially passing through the second gap, the through holes, and the first gap, exerts pressure on the first diaphragm, causing the first diaphragm and the second diaphragm to vibrate synchronously.

Optionally, at least one of the first diaphragm and the second diaphragm is provided with a conductive portion, the support structure is provided with a first metal through hole extending in a thickness direction thereof, and the conductive portion is provided with a first electrical connection portion led out through the first metal through hole.

Optionally, the backplate includes a conductive layer, and insulating layers respectively provided on two sides of the conductive layer;
the support structure is provided with a second metal through hole extending in a thickness direction thereof, and the conductive layer is provided with a second electrical connection portion led out through the second metal through hole.

According to a second aspect of embodiments of the present disclosure, a microphone is further provided, which includes:
a packaging structure; and
the MEMS acoustic sensing chip as described above, the MEMS acoustic sensing chip being provided inside the packaging structure.

According to a third aspect of embodiments of the present disclosure, an electronic device is provided, which includes the microphone as described above.

A technical effect of the embodiments of the present disclosure lies in:

The MEMS acoustic sensing chip provided by the present disclosure internally includes a double-diaphragm structure, wherein edges of the dual diaphragms are commonly supported on the substrate via the support structure. The design eliminates the need to provide the support pillars between the dual diaphragms, and locates the vent holes in the support regions of the dual diaphragms. This arrangement ensures that the vent holes are independent of the inner cavity formed between the vent holes and the vibration regions of the dual diaphragms. As a result, the acoustic performance in terms of sensitivity and signal-to-noise ratio (SNR) is maintained without increasing the area of the dual diaphragms, thereby facilitating miniaturization of the MEMS acoustic sensing chip. In addition, the absence of the support pillars between the dual diaphragms further improves the reliability of the MEMS acoustic sensing chip.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 is a first structural schematic diagram of a MEMS acoustic sensing chip provided by an embodiment of the present disclosure;

FIG. 2 is a second structural schematic diagram of the MEMS acoustic sensing chip provided by the embodiment of the present disclosure.

### DESCRIPTION OF REFERENCE SIGNS

1. Substrate; 10. Back cavity; 2. First diaphragm; 3. Second diaphragm; 4. Backplate; 41. Through hole; 5. Support structure; 6. Inner cavity; 61. First gap; 62. Second gap; 7. Vent hole; 8. Release hole; 9. First cavity; 11. First electrical connection portion; 12. Second electrical connection portion.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

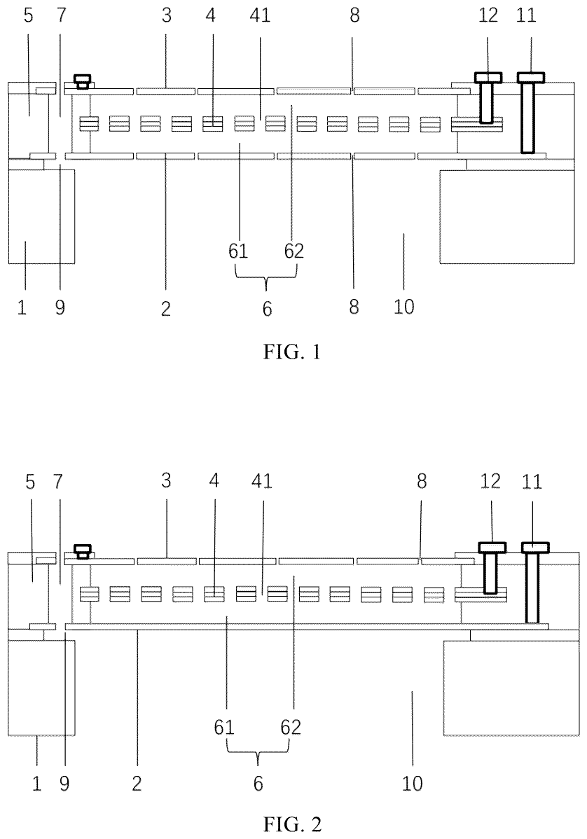

Referring to FIGS. 1 to 2, a MEMS acoustic sensing chip is disclosed, which includes a substrate 1, a first diaphragm 2, a second diaphragm 3, a backplate 4, and a support structure 5. The substrate 1 is provided with a back cavity 10;
the first diaphragm 2, the second diaphragm 3, and the backplate 4 are provided on one side of the substrate 1 through the support structure 5, the first diaphragm 2 and the second diaphragm 3 are provided with an inner cavity 6 therebetween, and the backplate 4 is suspended in the inner cavity 6;
the support structure 5 is provided with a vent hole 7, the vent hole 7 being in communication with the back cavity 10 and being independent of the inner cavity 6; and
at least one of the first diaphragm 2 and the second diaphragm 3 is provided with a release hole 8, which is in communication with the inner cavity 6.

Referring to FIG. 1, the MEMS acoustic sensing chip includes a substrate 1, with a back cavity 10 formed at the center of the substrate 1. A support structure 5 is provided on the substrate 1, and a first diaphragm 2, a backplate 4, and a second diaphragm 3 are sequentially stacked on the substrate 1 through the support structure 5. Herein, the first diaphragm 2 and the second diaphragm 3 are provided on both sides of the backplate 4 at an interval, forming an inner cavity 6 therebetween, with the backplate 4 suspended in the inner cavity 6.

In the present disclosure, the first diaphragm 2 and the second diaphragm 3 are supported on the substrate 1 via the support structure 5, and the arrangement of support pillars between the double diaphragms is omitted. According to the mechanical sensitivity formula Sm=dw/dp, wherein w is the effective displacement of the diaphragm and p is the sound pressure, if the first diaphragm 2 and the second diaphragm 3 are identical, the total mechanical sensitivity of the double-diaphragm structure is equal to half the mechanical sensitivity of a single-layer diaphragm. Furthermore, the arrangement of support pillars reduces the effective vibration area of the diaphragms, and affects the total mechanical sensitivity of the double-diaphragm structure. Therefore, the double-diaphragm structure without support pillars provided by the present disclosure exhibits significantly higher mechanical sensitivity than a double-diaphragm structure with support pillars.

Please continue to refer to FIG. 1, the support structure 5 is provided with a vent hole 7, the vent hole 7 being in communication with the back cavity 10. Thus, after the MEMS acoustic sensing chip provided by the present disclosure is packaged, the vent hole 7 enables communication of the back cavity 10 with the external environment to maintain pressure balance inside and outside the MEMS microphone and thus reduce the impact of high temperature or high pressure on the back cavity 10, thereby protecting the MEMS acoustic sensing chip.

Further, the vent hole 7 is independent of the inner cavity 6.

It should be noted that the vent hole 7 being independent of the inner cavity 6 emphasizes that gas in the vent hole 7 and the inner cavity 6 does not flow between each other. For example, gas flowing in the vent hole 7 will not enter the inner cavity 6. This does not define the separation of the vent hole 7 and the inner cavity 6 from each other in position.

Optionally, each of the first diaphragm and the second diaphragm includes a support region connected to the support structure, and the vent hole extends through both support regions of the first diaphragm and the second diaphragm.

Referring to FIG. 1, the first diaphragm 2 is provided on one side of the backplate 4 close to the substrate 1, and the second diaphragm 3 is provided on one side of the backplate 4 facing away from the substrate 1. During the process of gas flowing from the back cavity 10 to the external environment, gas in the back cavity 10 flows into the external environment through the vent hole 7. It should be noted that in this process, gas from the back cavity 10 does not flow into the inner cavity 6, avoiding interference with air flow in the inner cavity 6 and thus not affecting the vibration of the first diaphragm 2 and the second diaphragm 3.

Referring to FIGS. 1 to 2, at least one of the first diaphragm 2 and the second diaphragm 3 is provided with a release hole 8, which is in communication with the inner cavity 6. The release hole 8 is used to release the sacrificial layer between the first diaphragm 2 and the second diaphragm 3 during processing to form the inner cavity 6.

For example, as shown in FIG. 1, the first diaphragm 2 and the second diaphragm 3 located on both sides of the backplate 4 are both provided with release holes 8.

As another example, as shown in FIG. 2, the second diaphragm 3 on the side of the backplate 4 facing away from the substrate 1 is provided with a release hole 8.

As yet another example, the first diaphragm 2 on the side of the backplate 4 close to the substrate 1 is provided with a release hole 8.

In the prior art, the double-diaphragm MEMS microphone does not include support pillars, and the vent hole 7 is in communication with the inner cavity 6. Under this structure, the vent hole must meet the following conditions for typical venting of the packaged device:
acoustic sealing frequency f_{-3 dB}=fc=LFRO=1/(2πRvCb)<100 hz, determined by the acoustic resistance Rv of the vent hole and the acoustic compliance Cb of the back cavity 10

Herein, the LFRO of the existing MEMS microphone product generally ranges from 20 to 100 Hz.

However, when the vent hole satisfies fc<100 hz, another acoustic sealing frequency fc1=1/(2πRvCg)>=1000*fc>=20 kHz inevitably arises, which is determined by the acoustic compliance Cg of the inner cavity 6 of the double diaphragms and the acoustic resistance Rv of the vent hole, resulting in a severe “air leakage” condition where the first diaphragm 2 and the second diaphragm 3 cannot vibrate in response to sound pressure below fc1 (i.e., almost the entire audio frequency range) and thus rendering the device non-functional.

To address the above issue, the present disclosure provides a MEMS acoustic sensing chip including the first diaphragm 2 and the second diaphragm 3, wherein the support pillar structure between the first diaphragm 2 and the second diaphragm 3 is omitted. Additionally, the vent hole 7 provided between the first diaphragm 2 and the second diaphragm 3 is independent of the inner cavity 6. Since the release hole 8 is in communication with the inner cavity 6, the release hole 8 in the present disclosure is separated from the vent hole 7. Thus, the first diaphragm 2 and the second diaphragm 3 can still function normally without providing the support pillars therebetween.

By omitting the support pillar structure between the first diaphragm 2 and the second diaphragm 3, the effective capacitive area is increased. Therefore, under the premise of ensuring acoustic performance such as sensitivity and SNR, the area of the first diaphragm 2 and the second diaphragm 3 can be reduced, achieving miniaturization and low cost of the MEMS acoustic sensing chip. Moreover, by omitting the support pillar structure, it is also possible to reduce the likelihood of diaphragm fracture and device failure caused by stress concentration at the connection positions between the support pillars and the diaphragms, thereby significantly improving the reliability of the MEMS acoustic sensing chip. This not only facilitates the miniaturization of high-performance microphones but also greatly enhances the mechanical reliability of the device, addressing the major technical challenges faced by double-diaphragm microphones.

In the embodiments of the present disclosure, each of the first diaphragm 2 and the second diaphragm 3 includes a support region connected to the support structure 5, and the vent hole 7 extends through both support regions of the first diaphragm 2 and the second diaphragm 3.

Referring to FIG. 1, regions where the first diaphragm 2 and the second diaphragm 3 are connected to the support structure 5 are support regions. Herein, one end of the vent hole 7 passes through the support region of the first diaphragm 2, the other end of the vent hole 7 passes through the support region of the second diaphragm 3, and the two ends of the vent hole 7 are oppositely arranged. Additionally, the vent hole 7 extends through the support structure 5, is located outside the inner cavity 6, and is separated from the inner cavity 6 by the support structure 5.

In the embodiments of the present disclosure, each of the first diaphragm 2 and the second diaphragm 3 includes a vibration region covering the back cavity 10, and the release hole 8 is provided in the vibration region.

Referring to FIG. 1, the regions of the first diaphragm 2 and the second diaphragm 3 covering the back cavity 10 are the vibration regions, and the support regions surround the vibration regions. The vibration regions of the first diaphragm 2 and the second diaphragm 3 form the inner cavity 6 with the support structure 5. To achieve communication between the release hole 8 and the inner cavity 6, the release hole 8 is formed in the vibration regions of the first diaphragm 2 and the second diaphragm 3.

In the structure provided by the embodiments of the present disclosure, the vent hole 7 is formed in the support regions, and the release hole 8 is formed in the vibration regions, achieving spatial separation between the vent hole and the release hole 8 on the diaphragms. In other words, the vent hole 7 is arranged outside the vibration regions of the diaphragms/backplate 4, with no acoustic pathway to the inner cavity 6. This ensures that the vent hole 7 does not cause acoustic leakage for the first diaphragm 2 and the second diaphragm 3, guaranteeing normal operation of the MEMS acoustic sensing chip without performance loss.

In the embodiments of the present disclosure, the first diaphragm 2 is provided on one side of the backplate 4 close to the substrate 1, and the first diaphragm 2 and the substrate 1 are provided with a first cavity 9 therebetween, the first cavity 9 communicating the vent hole 7 with the back cavity 10.

Referring to FIG. 1, the first diaphragm 2 is provided between the backplate 4 and the substrate 1, and is spaced apart from the substrate 1, and the support region of the first diaphragm 2 is provided with the support structure 5. A first cavity 9 is further provided between the first diaphragm 2 and the substrate 1, and the first cavity 9 is in communication with the back cavity 10.

Specifically, during use, gas from the external environment enters the first cavity 9 through the vent hole 7 and then enters the back cavity 10 through the first cavity 9.

In the embodiments of the present disclosure, the release hole 8 has an aperture of less than 0.5 μm.

Preferably, the aperture of the release hole 8 ranges from 0.15 μm to 0.5 μm.

The acoustic resistance Rai of a single release hole 8 and acoustic compliance Cₐ₁ of the corresponding inner cavity 6 must satisfy the condition for acoustic sealing in the audio frequency range (20-20 kHz), i.e., fc=1/(2πRₐ₁Cₐ₁)<20 Hz or the roll-off point f_{-3 dB} (LFRO) of the frequency response performance of the device, for the device to function properly.

Specifically, assuming the release holes 8 have a radius R1 and a spacing P1, and are uniformly distributed on a diaphragm with thickness T1, the corresponding volume portion of the inner cavity 6 is P1²*Gap. Then:
the acoustic resistance of a single release hole 8: Rₐ₁=8μ T1/πR1⁴;
the acoustic compliance of the inner cavity 6: Cₐ₁=P1²*Gap/ρₐᵢᵣCₐᵢᵣ²;
wherein: μ is the air dynamic viscosity, ρₐᵢᵣ is the air density, and Cₐᵢᵣ is the speed of sound.

Based on estimates from existing double-diaphragm technology platforms, the diameter of the release holes 8 needs to be approximately 0.15 to 0.5 μm, which is significantly smaller than the size of a conventional vent hole. In this way, by using a large number of nanoscale release holes uniformly distributed over the diaphragm to release the sacrificial layer, the concentration of the etchant and the etching time required for releasing the sacrificial layer are significantly reduced, and as a result, the lateral stop layer structure is no longer necessary, which greatly reduces the process complexity and makes the MEMS acoustic sensing chip provided by the present disclosure more suitable for mass production and offers higher reliability.

In addition, environmental dust particles can seriously affect reliability of the device under normal conditions. Herein, the size of dust particles is approximately 1 μm to 5 μm, while the diameter of the release hole 8 in the present disclosure is smaller than the size of the environmental dust particles. Therefore, the structure provided by the present disclosure is not sensitive to the environmental dust particles and naturally has a “dust-proof” effect, significantly improving the dust-proof performance of the MEMS acoustic sensing chip provided by the present disclosure.

Furthermore, the MEMS acoustic sensing chip provided by the present disclosure also naturally exhibits excellent water resistance due to the extremely small size of the release hole 8. The pr/essure barrier formed by the microholes is given by: 2γ cos(θc)/R1>1 MPa, wherein γ is the surface tension of water and θc is the contact angle of the release hole material. Under normal circumstances in the industry, the waterproof pressure of 5 ATM is about 0.5 MPa. Therefore, the waterproof performance of the MEMS acoustic sensing chip provided by the present disclosure is significantly improved.

The MEMS acoustic sensing chip provided by the present disclosure maintains high performance (e.g., SNR, AOP), while offering higher reliability, particularly exhibiting superior performance over conventional products in terms of impact resistance, blow resistance, dust protection, and waterproofing.

In an embodiment of the present disclosure, on the first diaphragm 2 and/or the second diaphragm 3, adjacent release holes 8 are spaced apart by 10 μm to 30 μm.

During fabrication, conventional hydrofluoric acid-based etchants pass through the release hole 8 to etch away the sacrificial layer, and the etched sacrificial layer forms the inner cavity 6, while the unetched sacrificial layer forms the support structure 5. The spacing between the release holes 8 is controlled within 10 μm to 30 μm, which is much smaller than that in existing technologies. As a result, it is possible to correspondingly reduce the concentration of the hydrofluoric acid type etching solution used and reduce the etching time. In this way, it is possible to ensure the high mechanical reliability of the first diaphragm 2, the backplate 4, and the second diaphragm 3, to reduce the damage to the first diaphragm 2, the back plate 4, and the second diaphragm 3 due to the long-time etching of the high-concentration etching solution, and thus to ensure good acoustic performance of the MEMS acoustic sensing chip.

In an embodiment of the present disclosure, a first gap 61 is formed between the first diaphragm 2 and the backplate 4, and the two together form a first capacitor structure. A second gap 62 is formed between the second diaphragm 3 and the backplate 4, and the two together form a second capacitor structure.

Referring to FIGS. 1 and 2, the first diaphragm 2 is spaced apart from the backplate 4, and the first diaphragm 2 and the backplate 4 are formed with a first gap 61 therebetween and form a first capacitor structure.

Also referring to FIGS. 1 and 2, the second diaphragm 3 is spaced apart from the backplate 4, and the second diaphragm 3 and the backplate 4 are formed with a second gap 62 therebetween and form a second capacitor structure.

In the embodiment of the present disclosure, the backplate 4 is provided with a plurality of through holes 41, the first diaphragm 2 and the backplate 4 are formed with a first gap 61 therebetween, the second diaphragm 3 and the backplate 4 are formed with a second gap 62 therebetween, and the plurality of through holes 41 communicates the first gap 61 with the second gap 62;
when the second diaphragm 3 is subjected to sound pressure and moves towards the first diaphragm 2, air in the inner cavity 6 flows, and after sequentially passing through the second gap 62, the through holes 41, and the first gap 61, exerts pressure on the first diaphragm 2, causing the first diaphragm 2 and the second diaphragm 3 to vibrate synchronously.

The working principle of the MEMS acoustic sensing chip provided by the present disclosure is as follows, taking back-entrance sound as an example:
Sound enters the back cavity 10 through the back cavity 10 on the substrate 1, the first diaphragm 2 moves upward under sound pressure, the air in the inner cavity 6 flows under pressure, and after sequentially passing through the first gap 61, the through holes 41 provided on the backplate 4, and the second gap 62, the sound pressure is transmitted to the second diaphragm 3 to cause the second diaphragm 3 to move upward. It should be noted that since the volume of the inner cavity 6 is very small and its acoustic compliance is low, the air in the inner cavity 6 is pressurized and flows in the inner cavity 6 instead of contracting.

During this process, the air flow in the inner cavity 6 moves the first diaphragm 2 in conjunction with the second diaphragm 3. The backplate 4 remains stationary due to its high mechanical strength, and the MEMS acoustic sensing chip forms a differential capacitive microphone and is low THD and high AOP.

In the embodiment of the present disclosure, at least one of the first diaphragm 2 and the second diaphragm 3 is provided with a conductive portion, the support structure 5 is provided with a first metal through hole 41 extending in a thickness direction thereof, and the conductive portion is provided with a first electrical connection portion 11 led out through the first metal through hole 41.

In the embodiment of the present disclosure, the backplate 4 includes a conductive layer and insulating layers respectively provided on two sides of the conductive layer;
the support structure 5 is provided with a second metal through hole 41 extending in a thickness direction thereof, and the conductive layer is provided with a second electrical connection portion 12 led out through the second metal through hole 41.

With reference to FIGS. 1 to 2, a conductive portion is provided on each of the first diaphragm 2 and the second diaphragm 3, a third electrical connection portion is provided on a surface of the second diaphragm 3, and the third electrical connection portion is electrically connected to the conductive portion on the surface of the second diaphragm 3. The support structure 5 is provided with a first metal through hole 41 extending in a thickness direction thereof, and the conductive portion on the first diaphragm 2 is provided with a first electrical connection portion 11 led out through the first metal through hole 41.

The backplate 4 includes a conductive layer and insulating layers respectively provided on two sides of the conductive layer. A second metal through hole 41 extending in the thickness direction to the conductive layer is provided on the support structure 5, and the conductive layer is provided with a second electrical connection portion 12 led out through the second metal through hole 41.

The present disclosure further provides a microphone, which includes a packaging structure, and the MEMS acoustic sensing chip as described above, and the MEMS acoustic sensing chip is provided inside the packaging structure.

The present disclosure further provides an electronic device, which includes the microphone as described above.

The electronic device may be, for example, a mobile phone, a tablet, a head-mounted display device, or the like.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. A MEMS acoustic sensing chip, comprising a substrate provided with a back cavity, a first diaphragm, a second diaphragm, a backplate, and a support structure;
wherein the first diaphragm, the second diaphragm, and the backplate are provided on one side of the substrate through the support structure, the first diaphragm and the second diaphragm are provided with an inner cavity therebetween, and the backplate is suspended in the inner cavity;
and
at least one of the first diaphragm and the second diaphragm is provided with a release hole, the release hole being in communication with the inner cavity.

2. The MEMS acoustic sensing chip according to claim 1, wherein each of the first diaphragm and the second diaphragm comprises a support region connected to the support structure, and the support structure includes a vent hole extending through a support region of the first diaphragm and a support region of the second diaphragm.

3. The MEMS acoustic sensing chip according to claim 2, wherein the first diaphragm is provided on one side of the backplate close to the substrate, and the first diaphragm and the substrate are provided with a first cavity therebetween, the first cavity communicating the vent hole with the back cavity.

4. The MEMS acoustic sensing chip according to claim 1, wherein each of the first diaphragm and the second diaphragm comprises a vibration region covering the back cavity, and the release hole is provided in the vibration region.

5. The MEMS acoustic sensing chip according to claim 1, wherein the release hole has an aperture of less than 0.5 μm.

6. The MEMS acoustic sensing chip according to claim 1, wherein the release hole has an aperture of 0.15 μm to 0.5 μm.

7. The MEMS acoustic sensing chip according to claim 1, wherein adjacent release holes are spaced apart from 10 μm to 30 μm on the first diaphragm and/or the second diaphragm.

8. The MEMS acoustic sensing chip according to claim 1, wherein the first diaphragm and the backplate are formed with a first gap therebetween to form a first capacitor structure, and the second diaphragm and the backplate are formed with a second gap therebetween and form a second capacitor structure.

9. The MEMS acoustic sensing chip according to claim 1, wherein the backplate is provided with a plurality of through holes, the first diaphragm and the backplate are provided with a first gap therebetween, the second diaphragm and the backplate are provided with a second gap therebetween, and the plurality of through holes communicate the first gap with the second gap;
when the second diaphragm is subjected to sound pressure and moves towards the first diaphragm, air in the inner cavity flows and sequentially passes through the second gap, the through holes, and the first gap, thereby applying pressure on the first diaphragm and causing the first diaphragm and the second diaphragm to vibrate synchronously.

10. The MEMS acoustic sensing chip according to claim 1, wherein at least one of the first diaphragm and the second diaphragm is provided with a conductive portion, the support structure is provided with a first metal through hole extending in a thickness direction thereof, and the conductive portion is provided with a first electrical connection portion led out through the first metal through hole.

11. The MEMS acoustic sensing chip according to claim 1, wherein the backplate comprises a conductive layer, and insulating layers respectively provided on two sides of the conductive layer;
wherein the support structure is provided with a second metal through hole extending in a thickness direction thereof, and the conductive layer is provided with a second electrical connection portion led out through the second metal through hole.

12. A microphone, comprising:
a packaging structure; and
the MEMS acoustic sensing chip according to claim 1, the MEMS acoustic sensing chip being provided inside the packaging structure.

13. An electronic device, by comprising the microphone according to claim 12.

14. The MEMS acoustic sensing chip according to claim 1, wherein the release hole has an acoustic resistance Rₐ₁, and the inner cavity has an acoustic compliance Cₐ₁, such that
$$fc = 1 / ( 2 π {R}_{a 1} {C}_{a 1} ) < 20 Hz ,$$
$$with$$
$${R}_{a 1} = 8 μ T 1 / π R {1}^{4} ,$$
$${C}_{a 1} = P {1}^{2} * Gap / {ρ}_{air} {C}_{air}^{2} ,$$
μ being air dynamic viscosity,
ρₐᵢᵣ being air density,
Cₐᵢᵣ being speed of sound,
R1 being radius of the release hole,
T1 being thickness of the first diaphragm and/or the second diaphragm,
P1 being spacing between adjacent release holes, and
Gap being height of the inner cavity, which equals to the distance between the first diaphragm and the second diaphragm.

15. The MEMS acoustic sensing chip according to claim 1, wherein the release hole has an aperture of larger than 0.15 μm.

16. The MEMS acoustic sensing chip according to claim 1, wherein the support structure is provided with a vent hole, the vent hole being in communication with the back cavity and being independent of the inner cavity.
